(19) United States
(12) Patent Application Publication
(10) Pub. No.: US 2014/0149920 A1
(43) Pub. Date: May 29, 2014

(54) METHOD AND ELECTRONIC DEVICE FOR SWITCHING APPLICATION PROGRAMS

(71) Applicant: Samsung Electronics Co., Ltd., Gyeonggi-do (KR)

(72) Inventors: Chang WANG, Beijing (CN); Shu HAN, Beijing (CN)

(73) Assignee: Samsung Electronics Co., Ltd., Gyeonggi-do (KR)

(21) Appl. No.: 14/082,431

(22) Filed: Nov. 18, 2013

(30) Foreign Application Priority Data
Nov. 29, 2012 (CN) 201210499720.8

(51) Int. Cl. G06F 3/0482; G06F 3/0487; G06F 3/0484

(52) U.S. Cl. CPC G06F 3/0482; G06F 3/0484; G06F 3/0487
USPC 715/783

(57) ABSTRACT

A system switches application programs in an electronic device by storing data identifying a plurality of category groups of application programs, grouped based at least on application function. The system detects a manipulation operation command input for manipulation of operation of a first application program. In response to the manipulation operation command, the system uses the stored category group data in providing the user with displayed data identifying a second application program of at least one of, (a) the first category group and (b) a second category group of the plurality of category groups, different to the first category group. The system initiates execution of the second application in response to user selection of the second application program via the displayed data.

### CLAIM OF PRIORITY

This application claims priority under 35 U.S.C. §119(a) to a Chinese Patent Application filed in the State Intellectual Property Office on Nov. 29, 2012 and assigned Serial No. 201210499720.8, the content of which is herein incorporated by reference.

### TECHNICAL FIELD

The present disclosure relates to an electronic device for switching application programs for use in portable and other electronic devices.

### BACKGROUND

The proliferation of executable application programs in known electronic devices, improves user experience but causes difficulties for both skilled and unskilled users. A user may have difficulty in remembering a program name or other identifier and be unable to initiate or search or a desired executable application. A system according to invention principles addresses these deficiencies and related problems and provides an electronic device facilitating user access to a desired executable application program.

### SUMMARY

The system facilitates switching between application programs to improve the operation efficiency of an electronic device with a number of application programs. The system switches between application programs in an electronic device by storing data identifying a plurality of category groups of application programs, grouped based at least on application function. The system executes a first application program of a first category group of the plurality of category groups; detects a manipulation operation command input for manipulation of operation of the first application program. In response to the manipulation operation command, the system uses the stored category group data in providing the user with displayed data identifying a second application program of at least one of, (a) the first category group and (b) a second category group of the plurality of category groups, different to the first category group. Further, the system initiates execution of the second application in response to user selection of the second application program via the displayed data.

In a feature of the invention, the plurality of category groups comprise a plurality of themes and the system applies information used, acquired, or processed by the first application program in operating the second application program. The information used, acquired, or processed comprises one or more of, a search key word, input information, user-selected information and data stored on an electronic device. The system selects data from the information used, acquired, or processed in the first application program and applies the data to the second application program and displays application programs of the first or second category according to priority associated with likelihood of use by a particular user. The priority information of the priority is determined in response to at least one of, historical data identifying program usage habit of a user, usage frequency of an application program, update frequency of an application program, user-selected information and current status of an electronic device. The system configures manipulation operation in response to user settings and the manipulation operation comprises one of the following, dragging a directional predetermined image element towards right or left on a touch screen; a long duration touch of a right half part or left half part of a touch screen; a side of a palm contacting and sliding across a touch screen; and orientating an electronic device in a predetermined direction.

The system displays data identifying a third category group that has a degree of correlation with the first application program; and in response to user selection, provides data identifying the second application program that is located in a selected category group. In addition the system determines the degree of correlation of the third category group with the first application program according to at least one of, user current application operating information, user sequential operating command information, user status information, acquired input information, update information of application software and stored information. The system displays a third category group for the user to select by at least one of, displaying a representation of category groups using floating bubbles; displaying a representation of category groups at fixed positions in an image; displaying a representation of category groups in a list; and displaying a representation of category groups using stereoscopic cycling. The system determines degree of correlation between the first and second categories in response to at least one of, size of the area of a displayed element, position of the center of a displayed element, color depth of a displayed element, transparency of a displayed element, font size of the name of a category group, brightness of a displayed element, and distance between the center of a displayed element and the focus point of eyes. The system determines the second application program in the second category group in response to selected information.

In further feature of the invention, an electronic device switches application programs using a memory for storing data identifying a plurality of category groups of application programs, grouped based at least on application function. A detection module, is configured to detect a manipulation operation for manipulation of operation of a first application program. A judgment module, is configured to determine whether to perform an intra-category group switch between applications of a single category or perform an inter-category group switch between applications of different categories in response to the detected manipulation operation. A starting module, is configured to initiate execution of a second application program according to the determination, and initiating execution of the second application in response to user selection of the second application program via displayed data.

In another invention feature the plurality of category groups comprise a plurality of themes and the detection module further comprises an information recording unit, configured to store information used, acquired or processed by the first application program and to apply the information in operating the second application program. The used, acquired, or processed information comprises at least one of, a search key word, user input information, user-selected information and data stored on the electronic device. Also the judgment module comprise a data selection module, configured to select data from the information used, acquired, or processed by the first application program and apply the data to the second application program. The judgment module further comprises a priority determination unit, configured to determine the priority of the second application program, and provide priority information to the starting module; and the starting module displays application programs for the user to select based on the priority information. The priority information is determined in response to at least one of, historical data indicating a user habit, usage frequency of an application program, update frequency of an application program, user-selected information and current status of the electronic device. The system provides users with application programs correlated with an application program currently being used based on degree of correlation among themes and among application programs, saves user time in searching application programs.

Further, the system automatically switches between application programs based on degree of correlation between application programs, so that a user does not have to carry out multiple application open and close operations.

The additional aspects and advantages of the present invention will be provided in the following description, which will be apparent from the following descriptions or acquired from the exercise of the present invention.

### BRIEF DESCRIPTION OF THE DRAWINGS

The foregoing and/or additional aspects and advantages of the invention will be apparent and easily understood from the following description of embodiments with the accompanying drawings, in which:

FIG. 1 shows a flowchart of a method for switching application programs based on theme groups according to invention principles;

FIG. 2 shows a flowchart of a method for switching an intra-theme group application program according to invention principles;

FIG. 3 shows a flowchart of a method for switching an inter-theme group application program according to invention principles;

FIG. 4 shows a schematic bubble diagram illustrating displaying theme groups according to invention principles;

FIG. 5 shows a schematic diagram illustrating displaying theme groups by way of a first method using fixed positions according to invention principles;

FIG. 6 shows a schematic diagram illustrating displaying theme groups by way of a second method using fixed positions according to invention principles;

FIG. 7 shows a schematic diagram illustrating displaying theme groups by way of a third method using fixed positions according to invention principles;

FIG. 8 shows a schematic diagram illustrating displaying theme groups by way of a list according to invention principles;

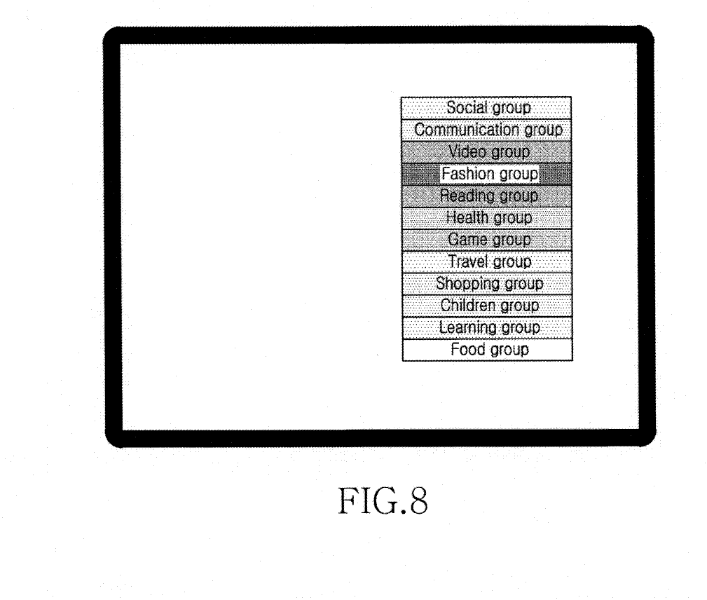

FIG. 9 shows a schematic diagram illustrating displaying theme groups by way of stereoscopic cycling according to invention principles; and

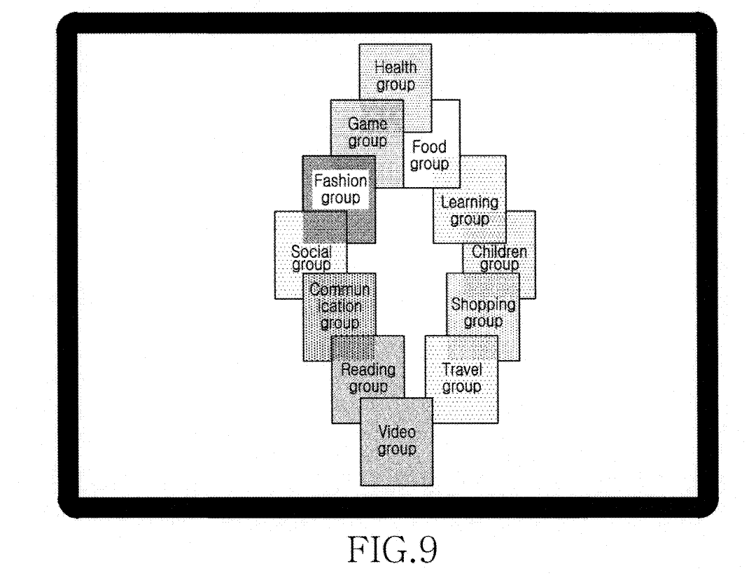

FIG. 10 is a structural diagram showing an electronic device switching application programs based on theme groups according to invention principles.

### DETAILED DESCRIPTION

Embodiments of the present invention will be described in detail hereafter. The examples of the embodiments will be illustrated by the accompanying drawings, wherein similar or same numeral symbols indicate similar or same elements or elements with same or similar functions. The embodiments described with reference to the drawings are intended to explain the present invention and should not be construed as limitation to the present invention.

It will be understood by the skilled in the art that the singular forms “a”, “an”, “the”, and “said” may be intended to include plural forms as well, unless the context clearly indicates otherwise. It should be further understood that the terms “comprises/comprising” used in this specification specify the presence of stated features, integers, steps, operations, elements, and/or components, but do not preclude the presence or addition of one or more other features, integers, steps, operations, elements, components, and/or groups thereof. It should be understood that when a component is referred to as being “connected to” or “coupled to” another component, it can be directly connected or coupled to the other element or intervening elements may be present. In addition, the “connected to” or “coupled to” may also refer to wireless connection or couple. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Those skilled in the art will understand that the term “terminal” used herein encompasses not only devices with a wireless signal receiver having no emission capability but also devices with receiving and emitting hardware capable of carrying out bidirectional communication over the two-way communication link. This kind of devices may include a cellular or other communication device with or without a multi-line display; a personal communication system (PCS) with combined functionalities of voice and data processing, facsimile and/or data communication capability; may include a PDA having a RF receiver and an internet/intranet access, web browser, notepad, calendar and/or global positioning system (GPS) receiver; and/or a conventional laptop and/or palm computer or other devices having a RF receiver. The “mobile terminal” used herein may refer to portable, transportable, fixed on a transportation (aviation, maritime and/or terrestrial) or suitable for and/or configured to run locally and/or run in the form of distribution on the earth and/or other places in the spaces. The “mobile terminal” used herein may also refer to a communication terminal, Internet terminal, music/video player terminal. The “mobile terminal” used herein may also refer to PDA, MID, and/or mobile phone with music/video playback capabilities etc. The “mobile terminal” as used herein may also be a smart TV, set-top box etc.

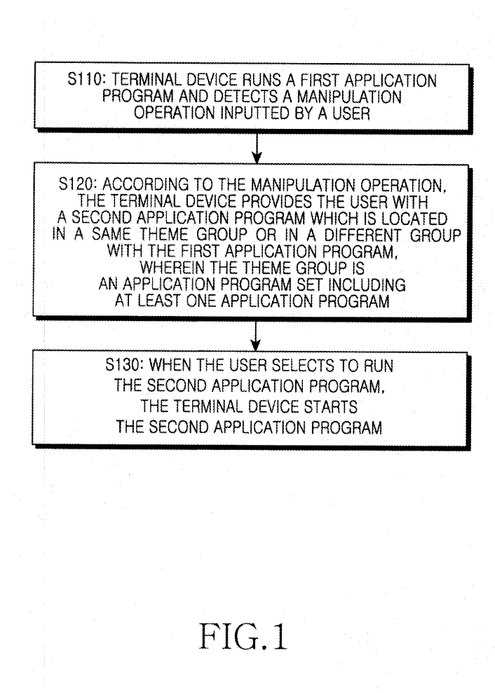

FIG. 1 shows a flowchart of a method for switching application programs based on theme groups. In step S110, the electronic device executes a first application program and detects a manipulation operation input by a user. In step S120, in response to the manipulation operation, the electronic device provides the user with a second application program which is located in the same theme group with the first application program or in a different group from the first application program, where the theme group is an application program set including at least one application program. In step S130, in response to the user selecting to run the second application program, the electronic device initiates execution of the second application program.

The electronic device categorizes application programs frequently used by the user according to recognition methods including in response to identity of application program functions. A user employs a process to form one or more theme groups categorized based on the type of application programs. For example, the electronic device categorizes application programs in response to a communication group, social group, movie & TV group, reading group, shopping group, learning group, game group, travel group, finance group, children group, food & health group, fashion group, and/or housing group.

As used herein, a theme group is a set of multiple application programs having a degree of correlation. When there is only one application program, the function of the theme group is the function of the contained application program. A theme group may comprise one or more application programs. The degree of correlation comprises an abstract or other relationship among application programs, and this relationship is a common characteristic of multiple application programs having similar, the same or related functions. Further, a degree of correlation exists as a causal logic relationship between a preceding first application program and a following second application program or between a first theme group containing the preceding first application program and a second theme group containing the following second application program. Further, the causal logic relationship (i.e., correlation degree) for example, includes but is not limited to, having the same, similar or a related function, a user command to initiate execution of an application program, an output result of an application program, input information of an application program, a manipulation operation input by the user, and/or information used, acquired or processed by an application program. Further, the information used, acquired or processed by an application program includes but is not limited to, historical usage and habit of a user, usage frequency of an application program or function, update frequency of an application program, user-selected information and current status of an electronic device. Further, the causal logic relationship (i.e. correlation degree) includes but is not limited to user current operation, environment and time of user interaction, a user sequence of operations, information collected by an input device, update information indicating application software update and update of information stored by a user.

In current electronic devices, e.g. Galaxy series of SAMSUNG™ electronic devices, existing theme groups include, social group, movie & TV group, and reading group. According to the existing application programs, the theme groups include the following exemplary software, Communication group: GoogleTalk™, MSN™, Fetion™, QQ™, WeChat™, and ChatOn™; Social group: weibo™, Renren™, Kanxin001™, Facebook™, and Qzone™; Movie &T V group: iQiyi™, tv.sohu™, Youku™, PPS™, and YouTube™; Travel group: Baidu map™, tigerknows™, Google™ map, gyer™, and Ctrip™; Shopping group: taobao™, 360buy™, Suning™, Amazon™, and lashou™; Reading group: ks.sj.91.com™, ZCOM™, and ibuka™; Financial group: alipay™, lakala™, ebank™, and cmbchina™; Food group: dianping™, jiepang™, and Recipelink™; Health group: Yourself!Fitness™, office fitness™, and simple yoga™; Children group: Quintura Kids™, artographo™, and fairy tale; Learning group™: VOA English™, youdao dictionary™, and Lingopal Korean™; Fashion group: meilishuo™, hairstyle booth™, and fashion show™

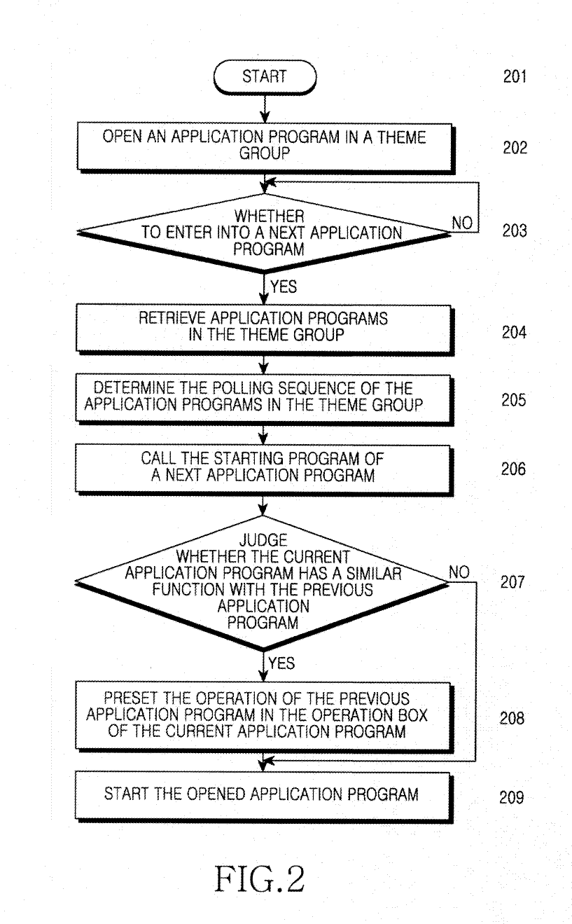

FIG. 2 shows a flowchart showing a process for switching an intra-theme group application program. The intra-theme group application program switching is also referred to as intra-theme group collaboration, i.e. categorizing application programs with similar or same functions in the electronic device, and forming theme groups having application program sets that realize certain user use requirements. Application programs in a same theme group can realize the collaboration function directly. In step 201 the electronic device (e.g. a smart mobile terminal) is activated and in step 202 an application program (having a certain function) in a theme group is opened. In step 203 the system determines whether to enter into a next application program (located in the same theme group) and in step 204 the system retrieves application programs (with a same or similar function) in the theme group. In step 205 the system determines the polling sequence of the application programs in the theme group and in step 206 initiates execution of a next application program. The system sorts application programs in the same theme group in response to their respective polling priorities in the theme group and initiates execution of an application program of the highest priority. In step 207, the system determines whether the current application program has a similar function as a previous application program and in step 208, populates data indicating the operation of the previous application program in an operation box of the current application program. In step 209 execution of the opened application program is initiated.

Further, in step 203 the system determines whether to execute a next application program in different determination modes including, in a first mode response to a user dragging a directional regular figure or in response to finger tracking on a touch screen or other UI command requesting execution of an application program in a current theme group. For example, when the touch direction is towards the right, a next application program in the current theme group is executed and when the touch direction is towards the left, a previous application program in the current theme group is executed. In a second mode, the system determines whether to execute a next application program in response to a user pressing a side of the touch screen for a time longer than a predetermined time to request entering into an application program in the current theme group. For example, when the right side on the touch screen is pressed, a next application program in the current theme group is executed; and when the left side on the touch screen is pressed, a previous application program in the current theme group is executed.

In a third mode, the system determines whether to execute a next application program in response to a user contacting the touch screen by the side of his palm and moving directionally to request execution of an application program in the current theme group. For example, when the side of his palm moves towards the right, a next application program in the current theme group is executed and when the side of his palm moves towards the left, a previous application program in the current theme group is executed. In a fourth mode, a next application program is selected in response to a user directionally orienting the electronic device to request switching application programs in the current theme group. For example, when the directional orientation is horizontally towards the right, a next application program in the current theme group is executed; and when the directional orientation is horizontally towards the left, a previous application program in the current theme group is executed. Therefore, the method of switching application programs comprises in response to predetermined configuration settings electronic device or user settings or in response to the previously described manipulation.

In step 205 the system determines a polling sequence of the application programs in the theme group in a first mode by in response to historical data indicating user habits and preference, e.g. a user tends to use different application programs in the same group at different times, with a particular frequently and location, and at particular user navigation speed. The system determines a polling sequence of the application programs in the theme group in a second mode by in response to frequency of use of different application programs by a user in a same theme group and in a third mode in response to update rate of the application programs in a same theme group. In a fourth mode polling sequence of the application programs is determined in response to selecting application programs of relatively large correlation degrees and precluding application programs that cannot be used at a current geographical position in response to user current geographical position information.

The correlation degree comprises synthesized information representing user intention and actions derived in response to user current terminal interaction operating information, user sequential operating command information, user status information, information acquired by an input device, update information identifying update of application software and information stored by the user. For example, it is inferred that a particular application program is likely to be executed by a particular user at a particular time following a particular sequence of terminal interactions indicated by a high degree of correlation with the particular application program. Therefore, correlating application programs or performing correlation comprises collating corresponding application programs according to their correlation degrees.

Therefore, the electronic device provides a user with a second application program by, polling the application programs in sequence according to their priorities and displaying data identifying them for the user to select according to priority information. Further, the priority information is determined in response to data indicating one or more of, user habit, historical activity record and preference as well as user frequency of employing an application program, the update frequency of an application program, user-selected information and current status of an electronic device employed. Further terminal status and lacks of operational resources is used by the system to enhance priority of an application program with reduced resource consumption.

In step 207, the system determines whether a current application program operates similarly to a previous application program based on similarity of function. If the applications have similar function, the electronic device applies the user same operation to different application programs having the similar function so as to simplify user operation. The electronic device automatically searches correlation information of the user, so that the user avoids having to repeat operations of a same type on different application programs. in response to user input of text via a user interface such as a search input box or status posting box, the electronic device stores the information and when a next application program needs to use the information, the electronic device searches and provides this information. In addition, when information input by the user needs to be published, the electronic device publishes and processes the information using a next application program without requiring user interaction.

In step 208 the system populates operation data in an operation box of an initiated application program based on similarity of operation with a previous application program and identifying a common operation among respective application programs in a theme group by collating data identifying processing operations of a similar function of the application programs in a theme group. Specifically, the electronic device provides information that a user needs to search or publish in a search box or status posting box, but does not perform operation processing. Rather, a user determines whether to perform the operation using the provided information. Alternatively, the system in an embodiment automatically performs the operation by default. The electronic device applies information used, acquired, or processed in a first application program including a search key word, user input information, user-selected information and data on an electronic device in operating a second application program.

Further, the system switches application programs by determining the correlation degree between the first application program and the second application program and applying data associated with the first application program to the second application program.

The intra-theme group application program switching, in response to a user terminating use of a first application program in a theme group, the electronic device initiates a second application program directly without user interaction and without need to return to an initial interface of the theme group or a main interface identifying application programs of the theme group. Further, the electronic device polls multiple application programs according to user usage frequency, and initiates execution of multiple second application programs in the same theme group in a sequence corresponding to usage frequency. In response to user input of query information in a particular application program of a theme group and retrieval of correlated results, the electronic device automatically recommends search results of varying correlation degree concurrently with initiating another application program in the same theme group.

The terminal system publishes (populates UI menus) and integrates information, including electronic device images, video files of multiple application programs in the same theme group concurrently to seamlessly operate intra-theme group application programs. The system determines whether a currently opened application program has a similar function as a previous used application program in response to input data and operation options of an application program interface. For example, Renren™, Kaixin001™ and t.qq™ in a social Hub have the function of posting web logs, pictures and status, so when a status is posted on a Renren™ application and a Sina weibo™ application is activated, the system determines that Sina weibo™ also has the function of posting status.

The system populates operating information in a currently opened application program in response to user operation of a previous application program and predetermined corresponding operating information in the current application program. For example, a status posted on Renren™ is provided in a status bar of Sina webo™ when Sina weibo™ is accessed, and a user determines if the status information is to be posted. Further, in response to a SAMSUNG™ galaxy™ mobile phone search on 360buy™, and Amazon™ is accessed, a search key word of SAMSUNG™ galaxy™ mobile phone is populated in the search bar for user acceptance or deletion.

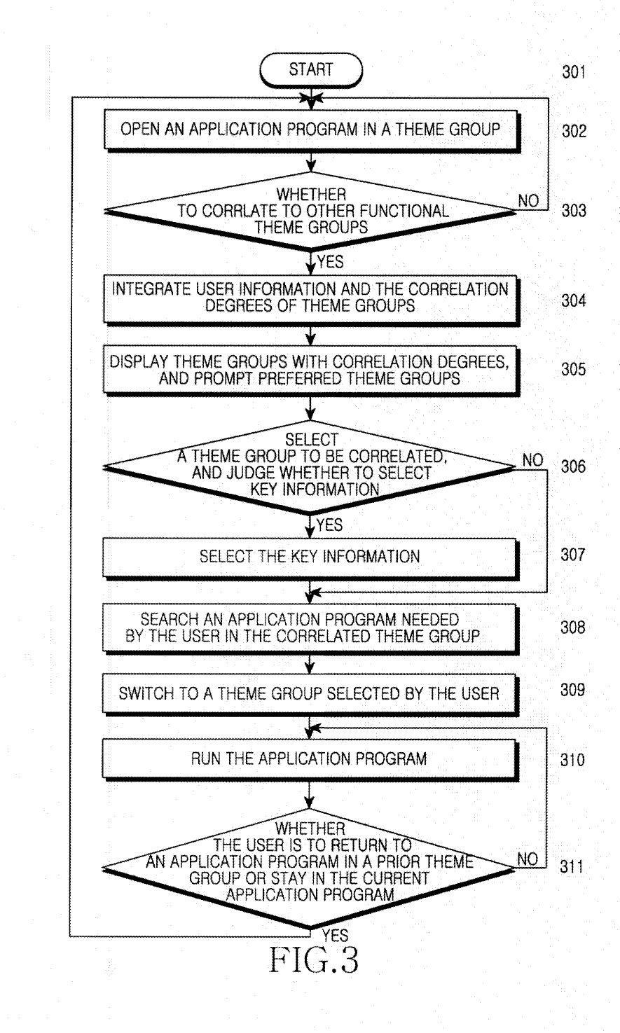

FIG. 3 shows a flowchart of a process for inter-theme group application program switching (interaction), i.e. categorizing application programs with similar or same functions in the electronic device to form application program theme groups that realize requirements of a user and provide collaboration between application programs in different theme groups. Switching application programs between different theme groups includes collaboration between groups and collaboration between programs inside a group, i.e. firstly switching between groups is performed, and switching between application programs is performed. the system can be further configured to switch from a first application program inside a group to a second application program in another group directly without performing the switching operation between groups first. In step 301, an electronic device is activated and in step 302 operation of an application program in a theme group is initiated. In step 303 the system determines whether to correlate other functional theme groups and in step 304 integrates user information and the correlation degrees of theme groups. For example, the electronic device collects user information and determines the correlation degrees between the theme groups. In step 305 the system displays data identifying theme groups and their correlation degrees, and prompts a user with preferred theme groups. in step 306 the system selects a theme group to be correlated, and determines whether to select key information (e.g., a field or a figure) and selects the key information in step 307. In step 308 the system searches an application program needed by a user in the correlated theme group and in step 309, switches to a theme group selected by the user. In step 310 the system runs the application program. For example, when running the application program, the electronic device preferably displays information needed by the user according to user requirements. In step 311 the system determines whether the user is to return to an application program in a prior (e.g. previous) theme group or stay in the current application program.

In step 303 the system determines whether the user is going to correlate other functional theme groups in response to, a user dragging a simple regular figure (e.g., dragging a relatively large circle) with a finger on the touch screen to request display of a correlated theme group, a user sequentially clicking twice on a touch screen using multiple fingers to request displaying a correlated theme group, contacting and covering the touch screen by using a whole palm or the side of a palm to request displaying a correlated theme group or by directionally orientating a. In step 304, the system integrates user information acquired by the electronic device and determines the correlation degrees between the theme groups based on a training correlation between different theme groups according to user habits and determining theme groups having correlation degrees with the theme group according to the theme group where the currently operated application program is located, and excluding theme groups with low correlation degrees.

The system determines correlation degrees between the theme groups based on selecting correlated theme groups for the user according to the environment where the user is located, current time and user habits and associated statistics derived based on averaged frequency of use data, or standard deviation, variance and other statistical parameters derived based on historical usage. The system determines requirements of the user in a current environment based on geographical position of the user and frequency of use of the geographical position. The system recommends different theme groups to a user based on user requirements according to the residency site, office site, and traveling location. If there is a big change in geographical position, e.g. change of city or country, the system recommends different theme groups to the user according to habits of a user at the changed geographical position. The system determines user requirements in a current environment according to user speed of movement. For example, when the user is still, moves slowly, or rapidly moves in transportation, requirements for application program theme groups are different. The electronic device records these different requirements and recommends different theme groups to the user based on user habit. The system determines the user requirements according to the time at a current geographic position. In different time periods of a day, the user requirements for application theme groups are different, and different theme groups are recommended to the user according to the user operation habits in several time periods.

The system selects a theme group based on consecutive operations performed on the electronic device, and correlation of theme groups is determined according to different application programs of the electronic device consecutively used by the user. The system recommends different theme groups to the user according to user information and information of the environment where the user locates collected by an input device such as a camera and a microphone. The system determines the number of users, gender and age of the user according to input user information via a camera and microphone and whether the user is in a quiet or noisy place. Preferred theme groups are also recommended to a user based on gender and age.

An application program theme group is a combination of application programs with a similar function, and different theme groups represent application programs contained therein. Based on key words frequently employed by the user and the user current operation, the system compares information update of application programs in theme groups and recommends a theme group containing a latest updated application program. The system selects correlated theme groups for the user in response to reminder information stored by the user including memo information and data traffic for example.

Therefore, when the electronic device determines that it is performing a inter-theme group application program switch, the electronic device starts theme group correlation and determines correlation degrees between other theme groups and the first application program. the electronic device provides other theme groups for the user to select according to the correlation degrees and electronic device provides the user with a second application program in a selected theme group. Further, the electronic device determines the correlation degrees between other theme groups and the first application program in response to, user current operating information, user consecutive operating interactions, user status information, information collected by an input device, update information of application software and information stored by the user.

In step 303, correlated theme groups are displayed in response to user command, and based on the correlation degree information between the theme groups recommends theme groups with relatively high correlation degrees, and excludes display of theme groups with low correlation degrees. In step 305 the system displays theme groups that can be correlated and provides preferred groups to the user.

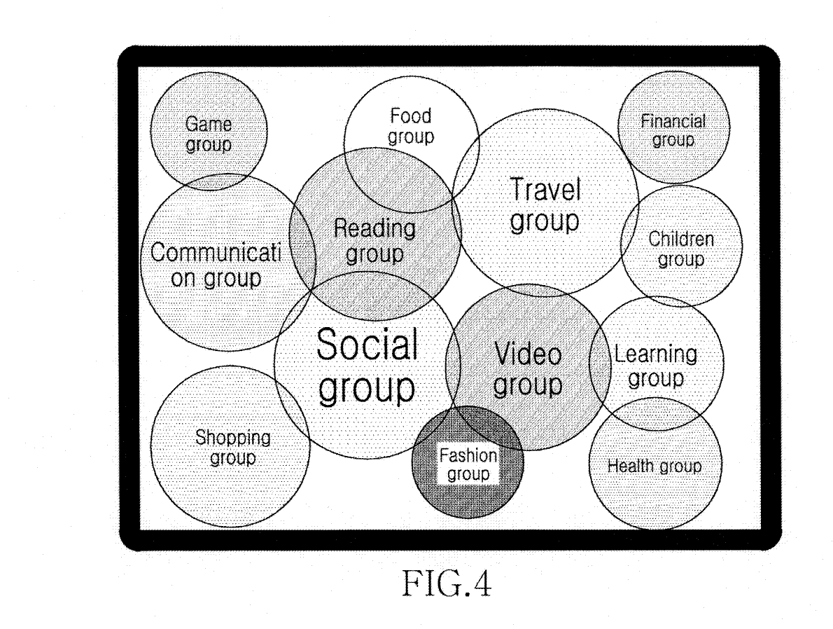

As shown in FIG. 4, the system displays theme groups using floating bubbles having an icon and name representing a theme group with different bubbles corresponding to different theme groups presented in different colors and degrees of transparency, and floating on irregular paths on a touch screen. Parameter values of each theme group figure to be displayed are determined according to the correlation between theme groups. Degree of correlation being indicated for a current theme group based on parameter values comprising, area of a theme group bubble, distance between the center of a theme group bubble and the focus point of the eyes, and transparency of a theme group bubble. Display parameters of corresponding different theme groups are allocated in response to weights given respective display parameters associated with the theme group bubbles so higher degree of correlation is given a greater weight.

The system enlarges the area of a bubble of the theme group to highlight a preferred theme group and conversely, for a theme group with a relatively low correlation degree weight, decreases the area of the bubble of the theme group. A total value of the area parameters of the theme groups to be displayed is consistent with a predetermined total bubble area. The system displays a preferred theme group, bubble at a position with a shortest distance between the center of the bubble and the focus point of the eyes and changing it as the focused position moves so as to highlight the bubble of the preferred theme group by making the bubble of theme group be closest to the focus point of the eyes. Conversely, for a theme group with a relatively low correlation degree, the system displays it at a position where there is a relatively long distance between the center of the bubble and the focus point of the eyes to illustrate relatively low correlation degree. The distances between the centers of the theme groups to be displayed and the focus point of the eyes are consistent with a preset distance between the center of the theme group and the focus point of the eyes.

For a bubble of a preferred theme group, the system reduces the parameter value of its transparency. Conversely, for a theme group with a relatively low correlation degree, the system increases the parameter value of its transparency, The total parameter value of the transparencies of the theme group bubbles is consistent with a preset total bubble transparency parameter value.

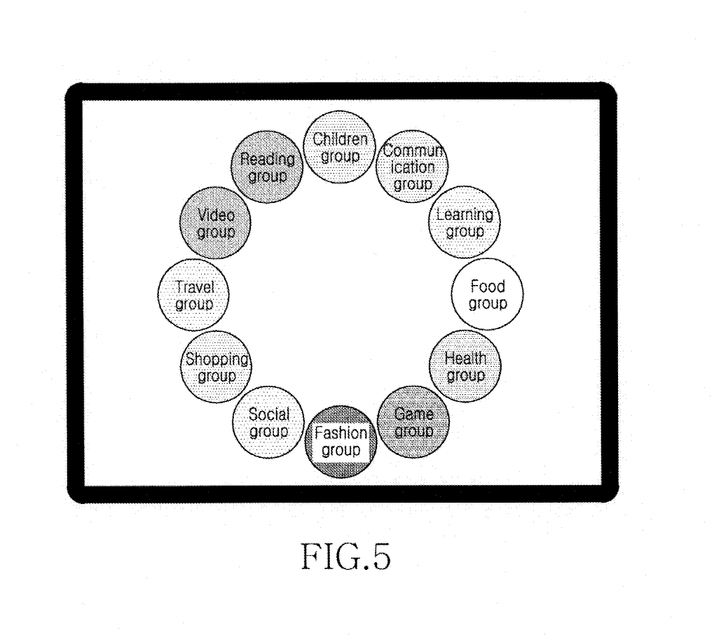

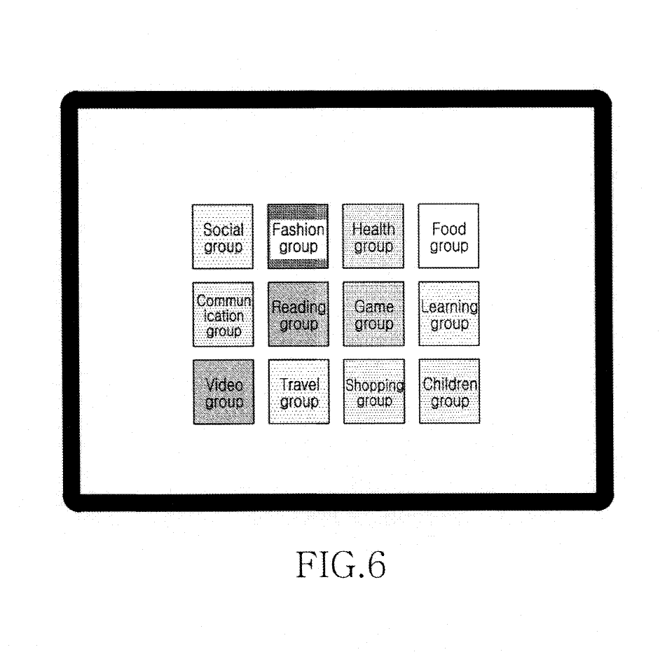

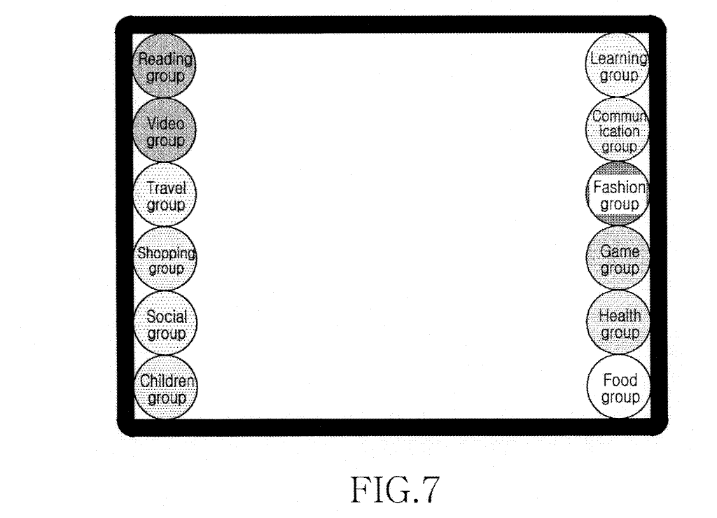

As shown in FIGS. 5-7, the system displays theme groups at fixed positions floating on the screen, using elements (e.g. round or rectangular) comprising multiple theme group icons having names to form a ring of the theme groups (as shown in FIG. 5) or a regular icon display (as shown in FIG. 6) in the middle of the interface, or displays the icons at the edge of the application program (as shown in FIG. 7). For example, for theme groups displayed in fixed positions, a preferred theme group is emphasized by enabling an icon of the theme group, increasing its brightness, and appearance in 3D stereoscopic effect, for example. The system increases the brightness of the icon of a preferred theme group and reduces the brightness of the icon of a preferred theme group with a relatively low correlation degree. The system inactivates a theme group having no correlation, displaying it with no color, and the user enables the theme group having no correlation by clicking it twice. The system arranges icons and names of theme groups in a concise list on the screen using list position and brightness to indicate degree of correlation. The system displays theme group elements on the screen using stereoscopic cycling vertical to the screen. An element comprises theme group icons and names, and in response to sliding the element up and down a screen by pointing the element, a next theme group element arranged clockwise or anti-clockwise vertical to the screen is displayed. For example, a preferred theme group is arranged at a position by a user selecting sliding and arranging a theme group with a relatively low correlation degree at a relatively rear position and a theme group is displayed in response to user consecutively sliding.

The electronic device displays other theme groups for the user to select including by, displaying floating elements; displaying at fixed positions, displaying by way of a list; and displaying by way of stereoscopic cycling. Further, when the electronic device displays other theme groups, the correlation degrees are indicated by size of the area of a displayed element, position of the center of a displayed element, color depth of a displayed element, transparency of a displayed element, font size of the name of a theme group, brightness of a displayed element, and distance between the center of a displayed element and the focus point of the eyes. For example, with a larger correlation degree, an element is larger; and with a larger correlation degree, the center of a image is closer to the center of the screen; with a larger correlation degree, the color is deeper; with a larger correlation degree, the transparency is smaller; with a larger correlation degree, the font is bigger; with a larger correlation degree, the brightness is higher; and with a larger correlation degree, the center of the element is closer to the focus point of the eyes. In addition, the above factors can function independently and can also be used in combination.

In step 306 the system determines a user selects a key word field or element and selects a related theme group from the theme groups displayed in step 305, and determines whether the user is likely to select key word or picture information in using a current application program. Selecting a theme group is performed by touching the theme group with a finger.

In step 307 user selection of a key word field or element is performed after it is determined that the user is selects key information on the current operation interface. For example, the key word can be selected by sliding a finger or touching text in the display area covered by a sign color similar to that of the selected theme group, and the selection becomes the key word used in step 308. For example, the key element can be selected by sliding two fingers to form a close element, and an key word on the display area covered by the closed element having the same color with the selected theme group becomes the key word of the operation in step 308. The electronic device determines a second application program in the selected theme group according to the information selected by the user.

Further, in step 308 the system searches related application processes that the user needs in the correlated theme group and transmits information that the user is likely to correlate two theme groups by, searching for use of an application process that the user needs to correlate the two theme groups. For example, in response to a key word being read at step 306, the system determines whether there is a key word and element selected at step 307. If no key word is selected, then an application program to be opened is selected in the selected theme group according to the method at step 305. If it is determined that a key word needs to be read at step 306 and the key word and element is read at step 307, the identity of the two theme groups to be correlated is output. This is performed using predetermined data associating user records of use of different application programs in the selected theme group together with the key word.

In step 309 switching to a user-selected theme group is performed as previously described in connection with step 303. In step electronic device 310, the system running the application program selected at step 308 and displaying the information needed by the user determines whether the user has selected key information, and presets the key information and displays it in the key word information bar. Further, in step 311 the system running an application program in the correlated theme group, determines whether to revert to a previous theme group based on degree of correlation. Theme group switching is performed in the manner previously described in connection with step 203.

The intra-theme group application program switching can include different application situations. In an example, at 9 pm at night, the user moving speed is 0, the scene is his daily residency site, the user is a young male according to camera input, the microphone input shows that the user is located in a relatively quiet environment, step counter application software indicates the number of user software interaction steps that day does not meet an expected value set by the user, if the user requests correlating theme groups, the health theme group is emphasized to as it has a relatively large correlation weight. The user selects the health group. In the health group, daily leg exercise software is the most frequently used software and a new set of leg exercise actions have been updated so when the user selects to enter into the health group, the daily leg exercise software is opened directly.

Further, when strange geographic position information is encountered in the social group or in the reading group, a web page provided by map application software in the travel group is switched to display relevant position information, and when further switching in the travel group, travel strategies at the relevant geographic positions are displayed. When a film or game is mentioned by a friend in the social group, relevant application programs in the movie&TV group or game group are executed directly, and the user requirement of watching the film and playing the game is started providing convenient user experience.

Further, when an application program in the social group is being operated, it has relatively high degree of correlation with the video group and communication group, and the display of the video group and communication group is emphasized. Also when an application program in the game group is being operated, it has relatively low degree of correlation with the travel group and financial group, and the display of the travel group and financial group is de-emphasized.

The system combines current time, moving speed and the geographic position where the user locates to recommend associated theme groups preferably for the user. For example, at 9 am in the morning, the user moves with a relatively fast speed, and it can be determined that the user is in a vehicle, and when the user makes a request for correlating theme groups, the display of the game group, reading group and video group frequently used by the user during the commute is emphasized. At 9 am in the morning, when the user is still and in a daily office site, it is determined that the user is working at office, and when the user makes a request for correlating theme groups, the display of the office group, communication group and learning group frequently used at office is emphasized. If the user stays in a travel city other than the hometown, different theme groups can be recommended to the user according to the user different habits, for example, when the user is in the hometown, he will cook food or play with his children at night, so the food&health group and children group is emphasized, and when the user is in a travel city, the social group and communication group is selected at night. The system recommends different theme groups to the user at different locations according to the trained user operation habits.

The system selects recommended correlated theme groups for the user according to the user consecutive operating information. For example, when the user just finished a call, searched a food name, beef noodle on a searching web page, and made a request for correlating theme groups, the user may have had an appointment with his friends to dinner and wants to search a travel route, so the travel group is a recommended theme group and is emphasized via prompt. If the user has just used the timer on the electronic device, searched a food name, beef noodle, and made a request for correlating theme groups, it likely the user was making dough, set the cooking time, and wants to see the recipe of the beef noodle, so the video group is recommended.

The system determines the user status according to the input of camera and microphone. For example, when based on the camera input it is determined that the user is a child, the game group, children group and learning group are recommended. When based on the camera input it is determined that the user is a young female, the shopping group, fashion group, video group and social group are recommended. When based on the camera input it is determined that the user is a young male, the reading group, video group, and game group are recommended; when based on the camera input it is determined that the user is an elder female, the shopping group, food & health group and travel group are recommended; when based on the camera input it is determined that the user is an elder male, the news group, office group and food&health group are recommended; and when based on the camera input it is determined that there are more than one user, for example, parents and children, the children group, video group and learning group are recommended. Further, when based on the microphone input it determined that the user is in a noisy environment, the compatible game group and video group are recommended, while the display of the learning group and office group commonly used in a quiet environment is de-emphasized.

The system recommends or excludes a theme group according to update information of application software. For example, if the user often searches movie star Bingbing FAN, when Bingbing FAN's weibo is updated in the social group, the display of the social group is strengthened when prompting theme groups, and if there is a premiere video of a movie stared by Bingbing FAN, the display of the video group is strengthened when prompting theme groups.

The system recommends a theme group according to prompt information stored by the user in the electronic device. For example, the user stores information about a certain time and a certain place that he had attended a meeting in his memo, during the period before this time, if the user makes a request for correlating theme groups, the display of the travel group containing travel information of leaving for the place and the weather group containing the weather there is emphasized. If the user inputs data traffic package quota for a data statistics reminder each month, when using the 3G or EDGE communications, if the data flow nearly reaches the package quota, the display of the video group with large data consumption is excluded.

The system selects application software to be opened in the correlated theme group according to the selected key word and the user habit. For example, when the selected key word is a TV serial name, then the video group is correlated; when the selected key word is Degang GUO, then YouKu in the video group is opened directly; when the selected key word is a movie title, then the application software Qiyi in the video group frequently used by the user to watch movies is opened; and if the user is in China, then YouTube is not started.

It can be understood that, to simplify the description, the respective (even preferable) implementations and algorithms having realization meaning of the intra-group collaboration between programs (the first part) and collaboration between groups (the second part) are given, while the parts with a similar or same meaning are omitted. Of course, for those skilled in the art can be inspired from the respective description of the two parts so as to combine respective implementations and algorithms with implementing meaning. Therefore, it can be understood that, referring to the cooperation of programs in a group and the cooperation of groups, the implementations and algorithms thereof may have common characteristics. For example, the polling of programs based on the priority can be used for polling of theme groups. For example, when performing inter-theme group application program switching, after enters into another theme group, the following executive scheme can be similar to the intra-theme group application program switching. For example, the operation method of the first application program can be used as the operation method of the second application program.

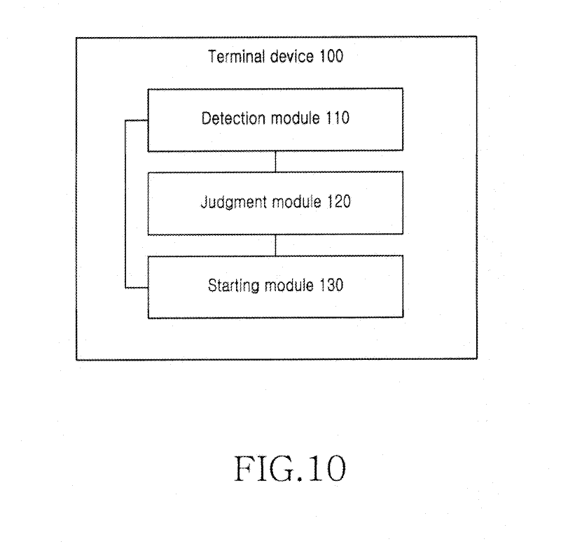

As shown in FIG. 10, another object of the present invention is an electronic device of switching application programs 100, which comprises: detection module 110, judgment module 120 and starting module 130.

In the above, the detection module 110 is configured to detect a manipulation operation input by the user according to a running first application program; the judgment module 120 is configured to judge whether to perform an intra-theme group switching or perform an inter-theme group switching according to the detected manipulation operation based on the detected manipulation operation; the starting module 130 is configured to invoke a second application program according to the judgment result, wherein a theme group is an application program set including at least one application program, and when the user selects to run the second application program, the electronic device 100 starting the second application program.

Further, the detection module 110 also comprises: information recording unit 111 (not shown) configured to record information used, acquired or processed during running the first application program and applies it to the second application program.

Further, the used, acquired, or processed information comprises one item of or multiple items of the following information: user' search key word, user input information, user-selected information and data on the electronic device 100. Further, the judgment module 120 comprises: data selection unit 121 (not shown) configured to select data from the used, acquired, or processed information in the first application program to use it in the second application program.

Further, the judgment module 120 also comprises: priority determination unit 122 (not shown), configured to determine the priority of the second application program, and provide the information of the priority to the starting module 130; and when the starting module 130 provides the user with the second application program, the starting module 130 polls the application programs in sequence according to their priorities and displaying them for the user to select according to the information of the priority.

Further, the priority information is determined according to one item of, or multiple items of, the following information: user habits, usage frequency of an application program, update frequency of an application program, user-selected information and current status of the electronic device 100. Further, the detection module 110 also comprises: setting unit 112 (not shown), configured to set the way of the manipulation operation according to the setting information received by the electronic device 100. Further, when the electronic device 100 identifies switching of an intra-theme group application program, the starting module 130 is further configured to start theme group correlation, and determine the degree of correlation between other theme groups and the first application program. According to the correlation degree, the electronic device 100 displays other theme groups for the user to select; and according to the user selection, the electronic device 100 provides the user with the second application program located in a selected theme group.

Further, the starting module 130 determines the correlation degrees of other theme groups with the first application program according to one item or multiple items as previously described.

Further, the starting module 130 is also configured to display other theme groups for the user to select as previously described. The system provides the user with other application programs that have a degree of correlation with the currently used application program and switches between application programs automatically based on the determined correlation.

The above-described embodiments can be implemented in hardware, firmware or via the execution of software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.”

It can be understood by those skilled in the art that the present invention have been described with reference to the structural diagrams and/or blocks and/or flowcharts of methods, systems, and computer programming products of the implementation of the present invention. It should be understood that each block in the structural diagrams and/or blocks and/or flowcharts or blocks combinations in these structural diagrams and/or blocks and/or flowcharts or blocks can be implemented by using computer programming instructions. These computer programming instructions can be provided to a general purpose computer, a specialized computer or other processors of programmable data processing methods to generate the machine, so that the instructions executed by a computer or processors of other programmable data processing methods to create the methods indicated by the boxes in the structural diagrams and/or block diagrams and/or flowcharts.

It can be understood by those skilled in the art that these computer programming instructions may also be loaded into a computer or other programmable data processing methods to make a sequence of operation steps can be executed on the computer or other programmable data processing methods to generate processes that can be implemented by the computer; thus the instructions executed on the computer or other programmable data processing methods provide steps for implementing steps indicated in the box or boxes in the structural diagrams and/or block diagrams and/or flowcharts.

It can be understood by those skilled in the art that the steps, measures, schemes in the various operations, methods and flowcharts that have been discussed can be alternated, changed, combined or deleted. Furthermore, other steps, measures, schemes having the various operations, methods and flowcharts that have been discussed can also be alternated, changed, rearranged, decomposed, combined or deleted. Furthermore, the steps, measures, and schemes in the traditional art or in the present invention can be alternated, changed, rearranged, decomposed, combined or deleted.

The exemplary implementations are disclosed in the accompanying drawings and the specification. Though certain terminologies are used herein for general and description usage purpose, and should not be constructed as limiting. It should be pointed out that for those ordinary skilled in the art, various modifications and improvements can be made without departing from the principle of the invention, and those modifications and improvements should be deemed as in the scope of the present invention. The protecting scope of the present invention should be defined by the claims of the present invention.

What is claimed is:

1. A method of switching application programs in an electronic device, comprising:
storing data identifying a plurality of category groups of application programs, grouped based at least on application function;
executing a first application program of a first category group of the plurality of category groups;
detecting a manipulation operation command input for manipulation of operation of the first application program;
in response to the manipulation operation command, using the stored category group data in the electronic device providing the user with displayed data identifying a second application program of at least one of,
(a) the first category group and
(b) a second category group of the plurality of category groups, different to the first category group; and
initiating execution of the second application in response to user selection of the second application program via the displayed data.

2. The method according to claim 1, wherein
the plurality of category groups comprise a plurality of themes and including, applying information used, acquired, or processed by the first application program in operating the second application program.

3. The method according to claim 2, wherein the information used, acquired, or processed comprises one or more of, a search key word, input information, user-selected information and data stored on the electronic device.

4. The method according to claim 3, including
selecting data from the information used, acquired, or processed in the first application program and applying the data to the second application program.

5. The method according to claim 1, including displaying application programs of the first or second category according to priority associated with likelihood of use by a particular user.

6. The method according to claim 5, wherein the priority information is determined in response to at least one of, historical data identifying program usage habit of a user, usage frequency of an application program, update frequency of an application program, user-selected information and current status of the electronic device.

7. The method according to claim 1, including,
configuring manipulation operation in response to user settings.

8. The method according to claim 1, wherein the manipulation operation comprises one of the following,
dragging a directional predetermined image element towards right or left on a touch screen;
a long duration touch of a right half part or left half part of a touch screen;
a side of a palm contacting and sliding across a touch screen; and
orientating the electronic device in a predetermined direction.

9. The method according to claim 1, including,
displaying data identifying a third category group that has a degree of correlation with the first application program; and
in response to user selection, providing data identifying the second application program that is located in a selected category group.

10. The method according to claim 9, including
determining the degree of correlation of the third category group with the first application program according to at least one of, user current application operating information, user sequential operating command information, user status information, acquired input information, update information of application software and stored information.

11. The method according to claim 9, including
displaying a third category group for the user to select by at least one of,
displaying a representation of category groups using floating bubbles;
displaying a representation of category groups at fixed positions in an image;
displaying a representation of category groups in a list; and
displaying a representation of category groups using stereoscopic cycling.

12. The method according to claim 9, including
determining degree of correlation between the first and second categories in response to at least one of, size of the area of a displayed element, position of the center of a displayed element, color depth of a displayed element, transparency of a displayed element, font size of the name of a category group, brightness of a displayed element, and distance between the center of a displayed element and the focus point of eyes.

13. The method according to claim 12, including determining the second application program in the second category group in response to selected information.

14. An electronic device for switching application programs, comprising:
a memory for storing data identifying a plurality of category groups of application programs, grouped based at least on application function;
a detection module, configured to detect a manipulation operation for manipulation of operation of a first application program;
a judgment module, configured to determine whether to perform an intra-category group switch between applications of a single category or perform an inter-category group switch between applications of different categories in response to the detected manipulation operation;
a starting module, configured to initiate execution of a second application program according to the determination, and initiating execution of the second application in response to user selection of the second application program via displayed data.

15. The electronic device according to claim 14, wherein the plurality of category groups comprise a plurality of themes and wherein, the detection module further comprises
an information recording unit, configured to store information used, acquired or processed by the first application program and to apply the information in operating the second application program.

16. The electronic device according to claim 15, wherein the used, acquired, or processed information comprises at least one of, a search key word, user input information, user-selected information and data stored on the electronic device.

17. The electronic device according to claim 16, wherein the judgment module comprises:
a data selection module, configured to select data from the information used, acquired, or processed by the first application program and apply the data to the second application program.

18. The electronic device according to claim 14, wherein, the judgment module further comprises a priority determination unit, configured to determine the priority of the second application program, and provide priority information to the starting module; and
the starting module displays application programs for the user to select based on the priority information.

19. The electronic device according to claim 18, wherein the priority information is determined in response to at least one of, historical data indicating a user habit, usage frequency of an application program, update frequency of an application program, user-selected information and current status of the electronic device.

20. The electronic device according to claim 14, wherein the detection module further comprises:
a setting unit, configured to determine the manipulation operation in response to received setting information.

21. The electronic device according to claim 14, wherein the manipulation operation comprises one of,
dragging a directional predetermined image element towards right or left on a touch screen;
a long duration touch of a right half part or left half part of a touch screen;
a side of a palm contacting and sliding across a touch screen; and
orientating the electronic device in a predetermined direction.

22. The electronic device according to claim 14, wherein the starting module is further configured to:
displaying data identifying another category group that has a degree of correlation with the first application program; and
in response to user selection, providing data identifying the second application program that is located in a selected category group.

23. The electronic device according to claim 22, wherein the starting module determines the degree of correlation of other category groups with the first application program in response to at least one of, user current application operating information, user sequential operating command information, user status information, acquired input information, update information of application software and stored information.

24. The electronic device according to claim 22, wherein the starting module displays other category groups for the user to select by,
displaying a representation of category groups using floating bubbles;
displaying a representation of category groups at fixed positions in an image;
displaying a representation of category groups in a list; and
displaying a representation of category groups using stereoscopic cycling.

25. The electronic device according to claim 22, wherein the judgment module determines the degree of correlation in response to at least one of, size of the area of a displayed element, position of the center of a displayed element, color depth of a displayed element, transparency of a displayed element, font size of the name of a theme group, brightness of a displayed element, and distance between the center of a displayed element and the focus point of eyes.

26. The electronic device according to claim 25, wherein the judgment module is further configured to determine the second application program in the selected category group in response to selected information.
